(19) United States
(12) Patent Application Publication
(10) Pub. No.: US 2024/0419839 A1
(43) Pub. Date: Dec. 19, 2024

(54) METHOD AND APPARATUS FOR JOINTLY TRAINING NATURAL LANGUAGE PROCESSING MODEL BASED ON PRIVACY PROTECTION

(71) Applicant: Alipay (Hangzhou) Information Technology Co., Ltd., Hangzhou (CN)

(72) Inventors: Jian DU, Hangzhou (CN); Fengran MO, Hangzhou (CN); Lei WANG, Hangzhou (CN)

(21) Appl. No.: 18/572,937

(22) PCT Filed: Oct. 14, 2022
(86) PCT No.: PCT/CN2022/125464

§ 371 Date: Jul. 22, 2024

(30) Foreign Application Priority Data
Dec. 13, 2021 (CN) 202111517113.5

(51) Int. Cl. G06F 21/62; G06F 40/40; G06N 20/00

(52) U.S. Cl. CPC G06F 21/6245; G06F 40/40; G06N 20/00

(57) ABSTRACT

Embodiments of this specification provide a method for jointly training a natural language processing (NLP) model based on privacy protection. The NLP model includes an encoding network located at a first party and a processing network located at a second party. According to the method, the first party obtains a local target training statement, inputs the target training statement to the encoding network, and forms a sentence representation vector based on an encoding output of the encoding network; and then adds target noise that conforms to differential privacy to the sentence representation vector, to obtain a target noise addition representation, and sends the target noise addition representation to the second party for training of the processing network.

This specification claims priority to Chinese Patent Application No. 202111517113.5, filed with the China National Intellectual Property Administration on Dec. 13, 2021 and entitled “METHOD AND APPARATUS FOR JOINTLY TRAINING NATURAL LANGUAGE PROCESSING MODEL BASED ON PRIVACY PROTECTION”, which is incorporated herein by reference in its entirety.

### TECHNICAL FIELD

One or more embodiments of this specification relate to the field of machine learning, and in particular, to a method and an apparatus for jointly training a natural language processing model based on privacy protection.

### BACKGROUND

With the rapid development of machine learning, various machine learning models are applied to various service scenarios. Natural language processing (NLP) is a common machine learning task, and is widely applied to a plurality of service scenarios, for example, user intention recognition, intelligent customer service question answering, machine translation, and text analysis and classification. For an NLP task, a plurality of neural network models and training methods are provided to enhance a semantic understanding capability of the NLP task.

It can be understood that for the machine learning model, model prediction performance depends heavily on richness and availability of training samples. To obtain a prediction model that has better performance and that is more suitable for an actual service scenario, a large quantity of training samples suitable for the service scenario usually need to be obtained. This is particularly true of NLP model for specific NLP tasks. To obtain rich training data and improve performance of the NLP model, in some scenarios, training data of a plurality of data parties is used to jointly train the NLP model. However, local training data of each data party usually includes privacy of a local service object, especially user privacy. This poses security and privacy challenges for multi-party joint training. For example, intelligent question answering is a specific downstream NLP task, and training data of the task requires a large quantity of question-answer pairs. In actual service scenarios, problems are usually raised by a user end. However, a user problem usually includes personal privacy information of a user. If the user problem from the user end is directly sent to another party, for example, a server, there may be a risk of privacy disclosure.

Therefore, it is expected that there can be an improved solution to protect data security and data privacy in a scenario in which the NLP model is jointly trained by a plurality of parties.

### SUMMARY

One or more embodiments of this specification describe a method and an apparatus for jointly training a natural language processing (NLP) model, to protect data privacy security of a training sample provider in a joint training process.

According to a first aspect, a method for jointly training a natural language processing (NLP) model based on privacy protection is provided. The NLP model includes an encoding network located at a first party and a processing network located at a second party. The method is performed by the first party and includes:
obtaining a local target training statement;
inputting the target training statement to the encoding network, and forming a sentence representation vector based on an encoding output of the encoding network; and
adding target noise that conforms to differential privacy to the sentence representation vector, to obtain a target noise addition representation, where the target noise addition representation is sent to the second party for training of the processing network.

According to an implementation, the obtaining a local target training statement specifically includes: performing sampling from a total local sample set based on a preset sampling probability p, to obtain a sample subset used for a current iteration round; and reading the target training statement from the sample subset.

In an implementation, the forming a sentence representation vector based on an encoding output of the encoding network specifically includes: obtaining a character representation vector obtained after the encoding network encodes each character in the target training statement; and performing a clipping operation based on a preset clipping threshold on the character representation vector of each character, and forming the sentence representation vector based on a clipped character representation vector.

Further, in an embodiment of this implementation, the clipping operation can include: if a current norm value of the character representation vector exceeds the clipping threshold, determining a ratio of the clipping threshold to the current norm value, and clipping the character representation vector based on the ratio.

In an embodiment of this implementation, the forming the sentence representation vector can specifically include: splicing clipped character representation vectors of all the characters to form the sentence representation vector.

According to an implementation, before the target noise is added, the method further includes: determining noise power for the target training statement based on a preset privacy budget; and obtaining the target noise through sampling from a noise distribution determined based on the noise power.

In an embodiment, the determining noise power for the target training statement specifically includes: determining, based on the clipping threshold, sensitivity corresponding to the target training statement; and determining the noise power for the target training statement based on a preset single-sentence privacy budget and the sensitivity.

In another embodiment, the determining noise power for the target training statement specifically includes: determining target budget information for a current iteration round t based on a preset total privacy budget used for a total quantity T of iteration rounds; and determining the noise power for the target training statement based on the target budget information.

In a specific example of this embodiment, the target training statement is obtained through sequential reading from a sample subset used for the current iteration round t, and the sample subset is obtained through sampling from a total local sample set based on a preset sampling probability p; and in this case, the determining the noise power for the target training statement specifically includes: converting the total privacy budget into a total privacy parameter value in Gaussian differential privacy space; determining a target privacy parameter value for the current iteration round t in the Gaussian differential privacy space based on the total privacy parameter value, the total quantity T of iteration rounds, and the sampling probability p; and determining the noise power based on the target privacy parameter value, the clipping threshold, and a quantity of characters in each training sentence in the sample subset.

Further, the target privacy parameter value for the current iteration round t can be determined as follows: The target privacy parameter value is inversely derived based on a first relational expression for calculating the total privacy parameter value in the Gaussian differential privacy space. The first relational expression shows that the total privacy parameter value is directly proportional to the sampling probability p and a square root of the total quantity T of iteration rounds, and depends on a result of a power operation in which a natural exponent e is used as a base and the target privacy parameter value is used as an exponent.

In different implementations, the encoding network can be implemented by using one of the following neural networks: a long short-term memory network (LSTM), a bidirectional LSTM, and a transformer network.

According to a second aspect, an apparatus for jointly training a natural language processing (NLP) model based on privacy protection is provided. The NLP model includes an encoding network located at a first party and a processing network located at a second party. The apparatus is deployed at the first party and includes:
a statement obtaining unit, configured to obtain a local target training statement;
a representation forming unit, configured to input the target training statement to the encoding network, and form a sentence representation vector based on an encoding output of the encoding network; and
a noise addition unit, configured to add target noise that conforms to differential privacy to the sentence representation vector, to obtain a target noise addition representation, where the target noise addition representation is sent to the second party for training of the processing network.

According to a third aspect, a computer-readable storage medium is provided. The computer-readable storage medium stores a computer program. When the computer program is executed in a computer, the computer is enabled to perform the method provided in the first aspect.

According to a fourth aspect, a computing device is provided, and includes a memory and a processor. The memory stores executable code. When the processor executes the executable code, the method provided in the first aspect is implemented.

In the solution for jointly training the NLP model provided in the embodiments of this specification, privacy protection is performed by using a local differential privacy technology and by using a training statement as a granularity. Further, in some embodiments, privacy amplification brought by sampling and superposition of privacy costs of a plurality of iteration rounds in a training process are considered to better design noise to be added to perform privacy protection, so that privacy costs of the entire training process are controllable.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram of an implementation architecture for jointly training an NLP model according to an embodiment;

FIG. 2 is a schematic diagram of privacy protection processing according to an embodiment;

FIG. 3 is a schematic flowchart of a method for jointly training an NLP model based on privacy protection according to an embodiment;

FIG. 4 shows a step procedure of determining noise power for a current training statement according to an embodiment; and

FIG. 5 is a schematic diagram of a structure of an apparatus for jointly training an NLP model according to an embodiment.

### DESCRIPTION OF EMBODIMENTS

The solutions provided in this specification are described below with reference to the accompanying drawings.

As described above, in a scenario in which a natural language processing (NLP) model is jointly trained by a plurality of parties, data security and privacy protection are problems that need to be concerned. How to protect privacy and security of data of each data party while exerting no impact on prediction performance of the trained NLP model as much as possible is a challenge.

Therefore, the embodiments of this specification provide a solution for jointly training an NLP model. In the solution, privacy protection is performed by using a local differential privacy technology and by using a training statement as a granularity. Further, in some embodiments, privacy amplification brought by sampling and superposition of privacy costs of a plurality of iteration rounds in a training process are considered to better design noise to be added to perform privacy protection, so that privacy costs of the entire training process are controllable.

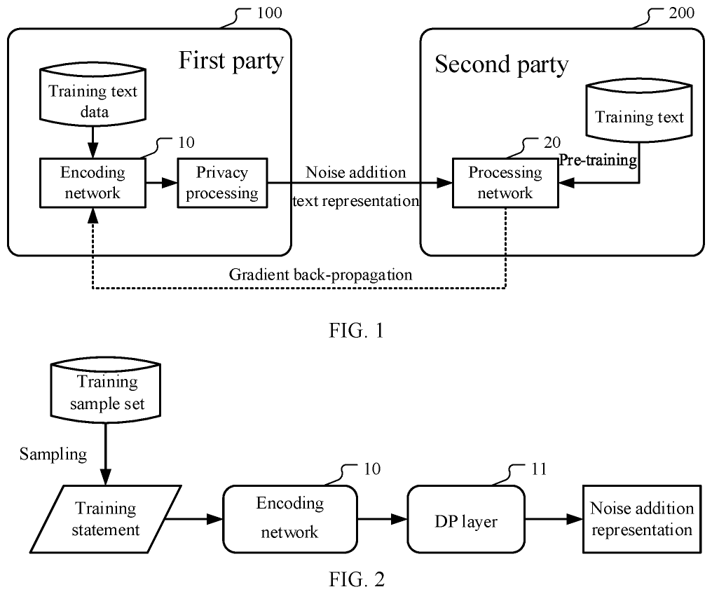

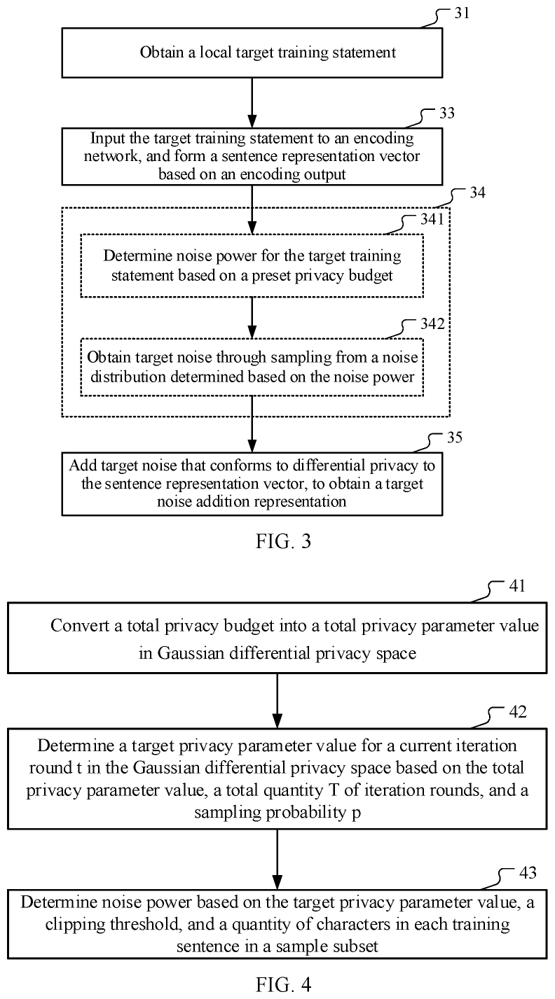

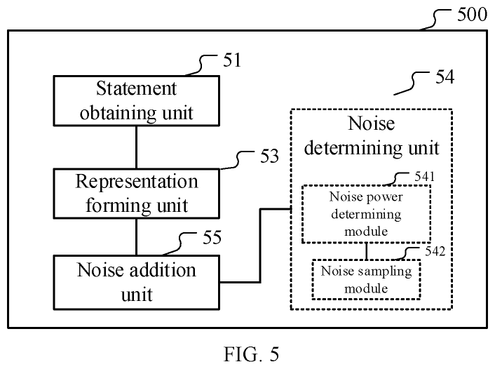

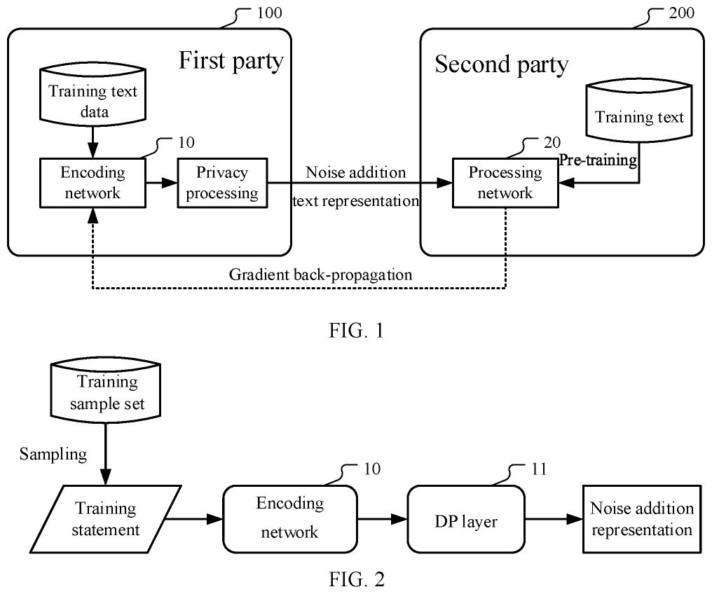

FIG. 1 is a schematic diagram of an implementation architecture for jointly training an NLP model according to an embodiment. As shown in FIG. 1, the NLP model for executing a specific NLP task is jointly trained by a first party 100 and a second party 200. Correspondingly, the NLP model is divided into an encoding network 10 and a processing network 20. The encoding network 10 is deployed at the first party 100, and is configured to encode an input text. The encoding processing can be understood as an upstream universal text understanding task. The processing network 20 is deployed at the second party 200, and is configured to further process an encoded text representation, and perform prediction related to the specific NLP task. That is, the processing network 20 is configured to perform a downstream processing process for the specific NLP task. The specific NLP task can be, for example, intelligent question answering, text classification, intention recognition, emotion recognition, or machine translation.

In different embodiments, the first party and the second party can be various data storage and data processing devices/platforms. In an embodiment, the first party can be a user terminal device, and the second party is a server device. The user terminal device performs joint training with the server by using a user input text locally collected by the user terminal device. In another example, both the first party and the second party are platform devices. For example, the first party is a customer service platform, and a large quantity of user problems are collected and stored in the first party; and the second party is a platform that needs to train a question answering model.

To train the NLP model, optionally, the second party 200 can first pre-train the processing network 200 by using local training text data of the second party 200; and then cooperate with the first party 100 to perform joint training by using training data of the first party 100. In a joint training process, the upstream first party 100 needs to send an encoded text representation to the downstream second party 200, so that the second party 200 continues to train the processing network 200 by using the text representation. In this process, the text representation sent by the first party 100 may carry user privacy information. This is prone to cause a risk of privacy disclosure. Although some privacy protection solutions such as user anonymization are provided, the user privacy information may be restored through de-anonymization processing. Therefore, privacy protection for information provided by the first party still needs to be enhanced.

Therefore, according to this embodiment of this specification, based on the idea of differential privacy, after a user text is input to the encoding network 10 as a training corpus, privacy protection processing is performed on an output of the encoding network 10, noise that meets differential privacy is added to the output, to obtain a noise addition text representation, and then such noise addition text representation is sent to the second party 200. The second party 200 continues to train the processing network 200 based on the noise addition text representation, and back-propagates gradient information, to implement joint training between the two parties. In the joint training process, the text representation sent by the first party 100 includes random noise, so that the second party 200 cannot learn of the privacy information in the training text of the first party. In addition, based on a principle of differential privacy, a noise amplitude to be added can be designed, so that model performance of the jointly trained NLP model is affected as little as possible.

FIG. 2 is a schematic diagram of privacy protection processing according to an embodiment. The privacy protection processing is performed in the first party 100 shown in FIG. 1. As shown in FIG. 2, the first party first reads a training statement from local user text data (used as a sample set) as a current input text. Optionally, the training statement can be obtained through sampling from the user text data. Then, the first party inputs the current input text to an encoding network 10, to obtain an encoding representation of the encoding network 10. According to this embodiment of this specification, a privacy processing layer 11 follows the encoding network 10. The privacy processing layer 11 is also referred to as a differential privacy (DP) layer below. The DP layer 11 is a non-parametric network layer, and performs privacy processing based on a preset hyper-parameter and algorithm, without the need to perform parameter adjustment and training. In this embodiment of this specification, for the current training statement, after obtaining a sentence representation based on encoding of the encoding network 10, the DP layer 11 applies noise that conforms to differential privacy to the sentence representation, to obtain a noise addition representation used as a text representation obtained after privacy processing, and sends the noise addition representation to a second party, to apply privacy protection by using the training statement as a granularity.

Before a detailed process of applying noise is described in detail below, a basic principle of DP is first briefly described.

Differential privacy (DP) is a means in cryptography and is intended to provide a way to maximize accuracy of a data query when a query from a statistical database is performed and minimize the opportunity of recognizing records in the database. A random algorithm M is set, and PM is a set including all possible outputs of M. For any two adjacent data sets x and x′ (that is, x and x′ have only one different data record) and any subset [symbol] of PM, if the random algorithm M meets the following formula:

$$Pr [ ℳ ( x ) ϵ𝒴 ] \leq {e}^{ε} Pr [ ℳ ( {x}^{′} ) ϵ𝒴 ] \qquad ( 1 )$$

the algorithm M provides E-differential privacy protection. Herein, the parameter ε is referred to as a privacy protection budget, and is used to balance a privacy protection degree and accuracy. The parameter ε usually can be preset. When the parameter ε is closer to 0, e^{ε} is closer to 1, processing results of the random algorithm for the two adjacent data sets x and x′ are more similar to each other, and the privacy protection degree is higher.

In practice, strict E-differential privacy shown in the formula (1) can be relaxed to a certain extent and implemented as (ε, δ) differential privacy, as shown in the following formula (2):

$$Pr [ ℳ ( x ) ϵ𝒴 ] \leq {e}^{ε} Pr [ ℳ ( {x}^{′} ) ϵ𝒴 ] + δ \qquad ( 2 )$$

Herein, δ is a relaxation term, is also referred to as tolerance, and can be understood as the probability that strict differential privacy cannot be implemented.

It should be noted that conventional differential privacy (DP) processing is performed by a database owner providing a data query. In the scenario shown in FIG. 1, after the NLP model is trained, the second party 200 provides a prediction result query for the specific NLP task. Therefore, the second party 200 serves as a server providing a data query. As shown in FIG. 1 and FIG. 2, in an implementation of this specification, the first party 100 locally performs privacy protection on a statement text (which is a training statement in a model training phase and is a query statement in a prediction use phase after model training), and then sends the statement text to the second party 200. Therefore, in the foregoing implementation, local differential privacy (LDP) processing is performed on a terminal side.

Implementations of differential privacy include a noise mechanism, an exponential mechanism, and the like. In a case of the noise mechanism, an amplitude of noise to be added is usually determined based on sensitivity of a query function. The sensitivity represents a maximum difference between query results of the query function when the query function queries a pair of adjacent data sets x and x′.

In the embodiment shown in FIG. 2, differential privacy is implemented by using the noise mechanism. Specifically, a training statement is used as a processing granularity, noise power is determined based on output sensitivity of the encoding network for the training statement and a preset privacy budget, and then corresponding random noise is applied to the sentence representation to implement differential privacy. Noise is applied on a scale of a sentence. This means that a granularity of privacy protection in the foregoing embodiment is a sentence level. Compared with privacy protection based on a word granularity, a privacy protection solution based on a sentence granularity is equivalent to hiding or blurring an entire sentence (including a series of words). Therefore, a privacy protection degree is higher, and a privacy protection effect is better.

With reference to specific embodiments, the following describes specific implementation steps of performing privacy protection processing in a first party.

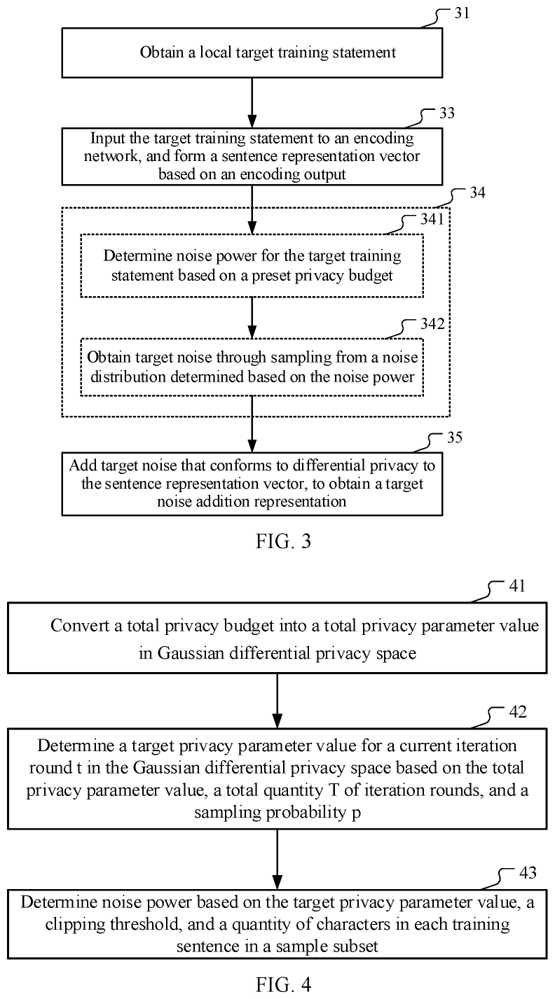

FIG. 3 is a schematic flowchart of a method for jointly training an NLP model based on privacy protection according to an embodiment. The NLP model includes an encoding network located at a first party and a processing network located at a second party. The following step procedure is performed by the first party. The first party can be specifically implemented as any server, apparatus, platform, or device that has a computing and processing capability, for example, a user terminal device or a platform device. The following describes in detail a specific implementation of each procedure step in FIG. 3.

As shown in FIG. 3, first, in step 31, a local target training statement is obtained.

In an embodiment, the target training statement is any training statement in a training sample set collected by the first party in advance. Correspondingly, the first party can sequentially or randomly read a statement from the sample set as the target training statement.

In another embodiment, in consideration of a plurality of rounds of iteration processes needed for training, in each iteration round, a small batch of samples (mini-batch) are obtained through sampling from a total local sample set to form a sample subset used for the round. The sampling can be performed based on a preset sampling probability p. Such a sampling process can also be referred to as Poisson sampling. It is assumed that it is currently in a t^{th} round of iteration process. Correspondingly, based on the sampling probability p, a current sample subset x^{t} for the current iteration round t is obtained through sampling. In this case, a statement can be sequentially read from the current sample subset x^{t} as the target training statement. The target training statement can be denoted as x.

It can be understood that the target training statement can be a statement that is related to a service object and that is obtained in advance by the first party, for example, a user question, a user chat record, a user input text, or another statement text that may be related to privacy information of the service object. Content of the training statement is not limited herein.

Then, in step 33, the target training statement is input to the encoding network, and a sentence representation vector is formed based on an encoding output of the encoding network.

As described above, the encoding network is configured to encode an input text, that is, execute an upstream universal text understanding task. Usually, the encoding network can first encode each character (token) (one character can correspond to one word or one punctuation mark) in the target training statement, to obtain a character representation vector of each character; and then perform fusion based on each character representation vector, to form the sentence representation vector. In specific practice, the encoding network can be implemented by using a plurality of neural networks.

In an embodiment, the encoding network is implemented by using a long short-term memory (LSTM) network. In this case, the target training statement can be converted into a character sequence, all characters in the character sequence are sequentially input to the LSTM network, and the LSTM network sequentially processes all the characters. At any moment, the LSTM network obtains, based on a hidden state corresponding to a previous input character and a current input character, a hidden state corresponding to the current input character, and uses the hidden state as a character representation vector corresponding to the current input character, to sequentially obtain character representation vectors corresponding to all the characters.

In another embodiment, the encoding network is implemented by using a bidirectional LSTM network, namely, BiLSTM. In this case, a character sequence corresponding to the target training statement can be input to the BiLSTM network twice in a forward sequence and a reverse sequence, to separately obtain first representations obtained when all characters are input in the forward sequence and second representations obtained when all the characters are input in the reverse sequence. A first representation and a second representation of the same character are fused, to obtain a character representation vector obtained after the character is encoded by the BiLSTM.

In still another embodiment, the encoding network is implemented by using a transformer network. In this case, each character in the target training statement can be input to the transformer network together with location information of the character. The transformer network encodes each character based on an attention mechanism, to obtain each character representation vector.

In another embodiment, the encoding network can alternatively be implemented by using another existing neural network that is suitable for performing text encoding. This is not limited herein.

The sentence representation vector of the target training statement can be obtained through fusion based on the character representation vector of each character. Based on features of different neural networks, fusion can be performed in a plurality of manners. For example, in an embodiment, character representation vectors of all the characters can be spliced to obtain the sentence representation vector. In another embodiment, weighted combination can be performed on all the character representation vectors based on the attention mechanism, to obtain the sentence representation vector.

According to an implementation, after the encoding network encodes each character to obtain the character representation vector, a clipping operation based on a preset clipping threshold can be performed on the character representation vector of each character, and the sentence representation vector can be formed based on a clipped character representation vector. The clipping operation blurs, to a certain extent, the character representation vector and the sentence representation vector that is further generated. More importantly, the clipping operation can facilitate measurement of sensitivity output by the encoding network for the training statement, to facilitate subsequent calculation of privacy costs.

As described above, in a noise mechanism, noise power needs to be determined based on the sensitivity, and the sensitivity represents a maximum difference between query results of a query function when the query function queries a pair of adjacent data sets x and x′. In a scenario in which the encoding network encodes the training statement, the sensitivity can be defined as a maximum difference between sentence representation vectors obtained after the encoding network encodes a pair of training statements. Specifically, x represents a training statement, and f(x) represents an encoding output of the encoding network. In this case, sensitivity Δ of the f function can be represented as a maximum difference between encoding outputs (sentence representation vectors) of two training statements x and x′, that is,

$$Δ = {max}_{x ∼ y} {‖ f ( x ) - f ( {x}^{′} ) ‖}_{2} \qquad ( 3 )$$

Herein, ∥·∥₂ represents a second-order norm.

It can be understood that if there is no constraint on a range of the training statement x, and there is no constraint on an output range of the encoding network, it is difficult to accurately estimate the sensitivity Δ. Therefore, in an implementation, the character representation vector of each character is clipped to limit the character representation vector to a specific range, to facilitate calculation of the sensitivity.

Specifically, in an embodiment, the clipping operation on the character representation vector can be performed as follows: If xᵥ represents a character representation vector of a v^{th} character in the target training statement x, it can be determined whether a current norm value (for example, a second-order norm value) of the character representation vector xᵥ exceeds the preset clipping threshold C. If the current norm value exceeds the preset clipping threshold C, xᵥ is clipped based on a ratio of the clipping threshold C to the current norm value.

In a specific example, a clipping process for the character representation vector xᵥ can be expressed by using the following formula (4):

$${\tilde{x}}_{v} {=}^{Δ} CL ( {x}_{v} ; C ) = {x}_{v} \cdot min ( 1 , \frac{C}{{‖ {x}_{v} ‖}_{2}} ) \qquad ( 4 )$$

In the formula (4), CL represents a clipping operation function, C is the clipping threshold, and min is a minimization function. When ∥xᵥ∥₂ is less than C, the ratio of C to ∥xᵥ∥₂ is greater than 1, and a value of the min function is 1. In this case, xᵥ is not clipped. When ∥xᵥ∥₂ is greater than C, the ratio of C to ∥xᵥ∥₂ is less than 1, and a value of the min function is the ratio. In this case, xᵥ is clipped based on the ratio, that is, all elements in xᵥ are multiplied by the ratio coefficient.

In an embodiment, splicing is performed based on the clipped character representation vector of each character, to form the sentence representation vector.

When the foregoing clipping is performed, if the training statement x includes n characters, the sensitivity output by the encoding network can be expressed as follows:

$$Δ = n \cdot C \qquad ( 5 )$$

It can be understood that the clipping threshold C is a preset hyper-parameter. A smaller value of the clipping threshold C indicates lower sensitivity and lower noise power that needs to be subsequently added. However, a smaller value of C indicates a higher clipping amplitude. This may affect semantic information of the character representation vector and further affect performance of the encoding network. Therefore, an appropriate value of the clipping threshold C can be set to balance the two factors.

On the basis of forming the sentence representation vector in step 33, in step 35, target noise that conforms to differential privacy is added to the sentence representation vector, to obtain a target noise addition representation. The target noise addition representation is subsequently sent to the second party for downstream training of the processing network by the second party. In an actual operation, each time a noise addition representation of a training statement is obtained, the first party can send the noise addition representation to the second party; or after obtaining noise addition representations of a small batch of training statements, the first party can send the noise addition representations to the second party together. This is not limited herein.

It can be understood that to implement differential privacy protection, it is of vital importance to determine the target noise. According to an implementation, before step 35, the method further includes step 34 of determining the target noise. Step 34 can include the following: First, in step 341, noise power (or a distribution variance) for the target training statement is determined based on a preset privacy budget; and then in step 342, the target noise is obtained through sampling from a noise distribution determined based on the noise power. In different examples, the target noise can be Laplacian noise that meets-differential privacy, Gaussian noise that meets (ε, δ) differential privacy, or the like. There can be a plurality of different implementations for determining and adding the target noise.

In an embodiment, the sentence representation vector is formed based on the clipped character representation vector, and Gaussian noise that conforms to (ε, δ) differential privacy is added to the sentence representation vector. In this embodiment, the obtained target noise addition representation can be expressed as follows:

$$ℳ ( x , f ( \cdot ) , ϵ , δ ) = CL ( f ( x ) ) + 𝒩 ( 0 , {σ}^{2} ) \qquad ( 6 )$$

Herein, CL(f(x)) represents the sentence representation vector formed based on the character representation vector obtained after the clipping operation CL, [symbol] (0, σ²) represents a Gaussian distribution in which a mean is 0 and a variance is σ², and σ² or σ can also be referred to as the noise power. Based on the formula (6), for the target training statement x, after the noise power σ² for the target training statement is determined, the random noise can be obtained through sampling from the Gaussian distribution formed based on the noise power, and superposed on the sentence representation vector to obtain the target noise addition representation.

In different embodiments, the noise power σ² corresponding to the target training statement can be determined in different manners, that is, step 341 is performed.

In an example, a privacy budget (εᵢ, δᵢ) is preset for a single (for example, an i^{th}) training statement. In this case, the noise power σ² can be determined based on the privacy budget set for the target training statement and the sensitivity Δ. The sensitivity can be determined, for example, based on the formula (5), the clipping threshold C, and a quantity of characters in the target training statement.

In an embodiment, in consideration of superposition of privacy costs, a total privacy budget is set for an entire training process. Superposition of privacy costs means that in a multi-step processing process such as NLP processing and model training, a series of calculation steps need to be performed based on a privacy data set, and each calculation step is potentially based on a calculation result of a previous calculation step that uses the same privacy data set. Even if DP privacy protection is performed in each step i by using privacy costs (εᵢ, δᵢ), when a plurality of steps are combined, a privacy protection effect may be overall severely degraded because of all steps. Specifically, in the training process of the NLP model, many iteration rounds, for example, thousands of rounds, need to be performed for the model. Even if a privacy budget for a single round and a single training statement is set to be very small, explosion of privacy costs usually occurs after thousands of iterations are performed.

Therefore, in an implementation, it is assumed that a total quantity of iteration rounds of the NLP model is T, and a total privacy budget (εₜₒₜ, δₜₒₜ) is set for the entire training process including the T iteration rounds. Target budget information for the current iteration round t is determined based on the total privacy budget, and then the noise power for the current target training statement is obtained based on the target budget information.

Specifically, in some embodiments, the total privacy budget (εₜₒₜ, δₜₒₜ) can be allocated to each iteration round based on a relationship between iteration steps, to obtain a privacy budget for the current iteration round t, and the noise power for the current target training statement is determined based on the privacy budget.

Further, in an embodiment, impact of differential privacy (DP) amplification caused in a sampling process on the privacy protection degree is further considered. Intuitively, when a sample is not included in a sampling sample set, the sample is completely confidential, and an effect brought by this is privacy amplification. As described above, in some embodiments, in each iteration round, a small batch of samples are obtained through sampling from a local sample set by using a sampling probability p, and used as a sample subset for the round. Usually, the sampling probability p is far less than 1. Therefore, DP amplification is brought in a sampling process of each round.

To better calculate allocation of the total privacy budget in comprehensive consideration of the impact of DP amplification caused due to privacy superposition and sampling, in an embodiment, the privacy budget in (ε, δ) space is mapped to dual space, namely, Gaussian differential privacy space, of the space, to facilitate calculation of privacy allocation.

Gaussian differential privacy is a concept provided in the paper “Gaussian Differential Privacy” published in 2019. According to this paper, a trade-off function T is introduced to measure privacy losses. It is assumed that a random mechanism M is applied to two adjacent data sets S and S′, an obtained probability distribution function is denoted as P and Q, and a hypothesis test is performed based on P and Q. It is assumed that @ is a deny rule in the hypothesis test. Based on this, a trade-off function of P and Q is defined as follows:

$$T ( P , Q ) ( α ) = inf \{ {β}_{ϕ} : {α}_{ϕ} \leq α \} \qquad ( 7 )$$

Herein, α_{ϕ} and β_{ϕ} respectively represent a first-type error rate and a second-type error rate of the hypothesis test in the deny rule Φ. Therefore, the trade-off function T can obtain a minimum value, namely, a minimum error sum, of the sum of the first-type error rate and the second-type error rate in the hypothesis test. A larger function value of T indicates higher difficulty in distinguishing between the two distributions P and Q.

Based on the foregoing definition, when the random mechanism M meets that a value of the trade-off function T is greater than a value of a continuous convex function f, that is, T( [symbol] (S), [symbol] (S′))≥f, the random mechanism M meets f-differential privacy, that is, f-DP. It can be proved that privacy representation space of f-DP forms dual space of (ε, δ)-DP representation space.

Further, in a range of f-DP, a very important privacy characterization mechanism, namely, Gaussian differential privacy (GDP), is provided. Gaussian differential privacy is obtained by selecting a special form for the function f in the foregoing formula. This special form is a function value of T between a Gaussian distribution in which a mean is 0 and a variance is 1 and a Gaussian distribution in which a mean is u and a variance is 1, that is, Gᵤ: =T( [symbol] (0,1), [symbol] (μ, 1)). That is, if the random algorithm M meets the following formula: T( [symbol] (S), [symbol] (S′)≥Gᵤ, the random algorithm M meets Gaussian differential privacy (GDP), denoted as G_{μ}-DP or μ-GDP.

It can be understood that in metric space of Gaussian differential privacy (GDP), privacy losses are measured by using a parameter u. In addition, as a type in an f-DP family, representation space of Gaussian differential privacy (GDP) can be considered as subspace of the representation space of f-DP, and is also used as dual space of the (ε, δ)-DP representation space.

A privacy metric in the Gaussian differential privacy (GDP) space and the (ε, δ)-DP representation space can be converted into each other by using the following formula (8):

$$δ ( ε ; μ ) = Φ ( - \frac{ε}{μ} + \frac{μ}{2} ) - {e}^{ε} Φ ( - \frac{ε}{μ} - \frac{μ}{2} ) \qquad ( 8 )$$

$$μ = Δ / σ \qquad ( 9 )$$

Herein, Φ(t) is an integral of a standard normal distribution, that is,

$$Φ ( t ) = ℙ [ 𝒩 ( 0 , 1 ) \leq t ] = \frac{1}{\sqrt{2 π}} {\int }_{- ∞}^{t} {e}^{- {y}^{2} / 2} dy .$$

In the metric space of Gaussian differential privacy (GDP), privacy superposition has a very simple calculation form. It is assumed that all of n steps meet GDP, and μ values of the n steps are respectively μ₁, μ₂, . . . , and μₙ. Based on a principle of GDP, a superposition result of the n steps still meets GDP, that is, G_{μ}_{₁}⊗G_{μ}_{₂}⊗ . . . . ⊗G_{μ}_{ₙ}=G_{μ}, and a μ value of the superposition result is μ=\sqrt{μ₁²+ . . . +μₙ²}.

With reference to the procedure shown in FIG. 3, if it is currently in the iteration round t, x^{t} represents the sample subset obtained through sampling for the current iteration round t, |x^{t}| represents a quantity of training statements in the sample subset, xₖ^{t} represents a k^{th} sentence in the sample subset, and |xₖ^{t}| represents a quantity of characters in the sentence, based on the formula (5), sensitivity corresponding to the sentence can be expressed as follows:

$${Δ}_{k}^{t} = \vert {x}_{k}^{t} \vert \cdot C \qquad ( 10 )$$

With reference to the formulas (9) and (10), it can be assumed that noise addition processing for the k^{th} sentence meets |xₖ^{t}|·C/σₜ-GDP.

Based on a superposition principle in the space of GDP, after noise processing that meets GDP is separately performed on all training sentences in the sample subset for the round t, a superposition result still meets GDP, and a u value of the superposition result is as follows:

$${μ}_{train} = \frac{C}{{σ}_{t}} \sqrt{{\sum }_{k} {\vert {x}_{k}^{t} \vert}^{2}} \qquad ( 11 )$$

Privacy superposition losses μₜᵣₐᵢₙ for one iteration round are obtained above. However, a plurality of iteration rounds need to be performed to train the NLP model. When resampling is performed in each iteration round, in consideration of a privacy amplification effect in sampling, the foregoing superposition principle is no longer applicable between the iteration rounds. By studying the privacy amplification caused due to the sampling probability p in the GDP space, a central limit theorem in the GDP space can be obtained. That is, when privacy parameter values for all the iteration rounds are μₜᵣₐᵢₙ, and the quantity T of iteration rounds is large enough (approaches infinity), a total privacy parameter value after the T iteration rounds meets the following relational expression (12):

$${μ}_{tot}^{train} = {p}_{train} \cdot \sqrt{T ( {e}^{{μ}_{train}^{2}} - 1 )} \qquad ( 12 )$$

The relational expression shows that the total privacy parameter value μₜₒₜ^{train} is directly proportional to the sampling probability p (denoted as pₜᵣₐᵢₙ in the formula 12) and a square root of the total quantity T of iteration rounds, and depends on a result of a power operation in which a natural exponent e is used as a base and the privacy parameter value μₜᵣₐᵢₙ for a single iteration round is used as an exponent.

Therefore, with reference to the formulas (8) to (12), the privacy budget allocated to the current round t and the current target training statement can be calculated by using the GDP space, to determine the noise power for the target training statement. Specifically, it is assumed that the total privacy budget (εₜₒₜ, εₜₒₜ) is set for the entire training process including the total quantity T of iteration rounds. The noise power for the current target training statement can be determined based on the step shown in FIG. 4.

FIG. 4 shows a step procedure of determining the noise power for the current training statement according to an embodiment. It can be understood that the step procedure in FIG. 4 can be understood as a sub-step of step 341 in FIG. 3. As shown in FIG. 4, first, in step 41, the total privacy budget (εₜₒₜ, εₜₒₜ) represented in the (ε, δ) space can be converted into the GDP space, to obtain the total privacy parameter value μₜₒₜ^{train} after the T iteration rounds. Conversion can be performed based on the foregoing formula (8).

Then, in step 42, the privacy parameter value μₜᵣₐᵢₙ for a single iteration round is inversely derived by using the relational expression (12) in the central limit theorem. Specifically, based on the relational expression (12), the privacy parameter value μₜᵣₐᵢₙ can be calculated based on the total train privacy parameter value μₜₒₜ^{train}, the total quantity T of iteration rounds, and the sampling probability p, and can be used as a target privacy parameter value for the current iteration round t.

Then, in step 43, the noise power σₜ is determined based on the target privacy parameter value μₜᵣₐᵢₙ, the clipping threshold C, and a quantity of characters in each training sentence in the current sample subset. Specifically, the noise power applicable to the current iteration round t can be obtained based on the formula (11):

$${σ}_{t} = \frac{C}{{μ}_{train}} \cdot \sqrt{{\sum }_{k} {\vert {x}_{k}^{t} \vert}^{2}} \qquad ( 13 )$$

Based on the formula (13), the noise power is calculated for the sample subset for the iteration round t. Therefore, different iteration rounds correspond to different noise power, and any training statement in a sample subset for the same iteration round (for example, the iteration round t) shares the same noise power. Therefore, the corresponding noise power σₜ is determined based on the sample subset for the iteration round in which the target training statement is located.

Therefore, the random noise can be obtained through sampling from the Gaussian distribution formed based on the noise power, and the random noise is superposed on the sentence representation vector to obtain the target noise addition representation, as shown in the foregoing formula (6). By using the noise determined in this manner, the condition that the privacy losses meet the preset total privacy budget (εₜₒₜ, εₜₒₜ) after the T iteration rounds can be met.

In a review of the entire process, in the process of jointly training the NLP model in this embodiment of this specification, the upstream first party performs privacy protection by using a local differential privacy technology and by using a training statement as a granularity. Further, in some embodiments, privacy amplification brought by sampling and superposition of privacy costs of a plurality of iteration rounds in a training process are considered to accurately calculate, in the Gaussian differential privacy (GDP) space, noise to be added in each iteration round to perform privacy protection, so that total privacy costs of the entire training process are controllable to better implement privacy protection.

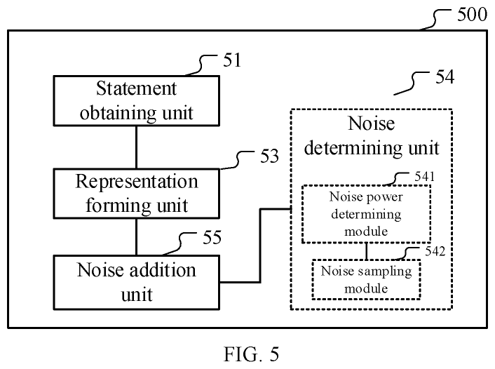

In addition, corresponding to the joint training, an embodiment of this specification further discloses an apparatus for jointly training an NLP model based on privacy protection. The NLP model includes an encoding network located at a first party and a processing network located at a second party. FIG. 5 is a schematic diagram of a structure of an apparatus for jointly training an NLP model according to an embodiment. The apparatus is deployed at the foregoing first party. The first party can be implemented as any computing unit, platform, server, device, or the like that has a computing and processing capability. As shown in FIG. 5, the apparatus 500 includes:
a statement obtaining unit 51, configured to obtain a local target training statement;
a representation forming unit 53, configured to input the target training statement to the encoding network, and form a sentence representation vector based on an encoding output of the encoding network; and
a noise addition unit 55, configured to add target noise that conforms to differential privacy to the sentence representation vector, to obtain a target noise addition representation, where the target noise addition representation is sent to the second party for training of the processing network.

According to an implementation, the statement obtaining unit 51 is configured to perform sampling from a total local sample set based on a preset sampling probability p, to obtain a sample subset used for a current iteration round; and read the target training statement from the sample subset.

In an implementation, the representation forming unit 53 is configured to obtain a character representation vector obtained after the encoding network encodes each character in the target training statement; and perform a clipping operation based on a preset clipping threshold on the character representation vector of each character, and form the sentence representation vector based on a clipped character representation vector.

Further, in an embodiment of this implementation, the clipping operation performed by the representation forming unit 53 specifically includes: if a current norm value of the character representation vector exceeds the clipping threshold, determining a ratio of the clipping threshold to the current norm value, and clipping the character representation vector based on the ratio.

In an embodiment of this implementation, the representation forming unit 53 is specifically configured to splice clipped character representation vectors of all the characters to form the sentence representation vector.

According to an implementation, the apparatus 500 further includes a noise determining unit 54, specifically including:
a noise power determining module 541, configured to determine noise power for the target training statement based on a preset privacy budget; and
a noise sampling module 542, configured to obtain the target noise through sampling from a noise distribution determined based on the noise power.

In an embodiment, the noise power determining module 541 is configured to determine, based on the clipping threshold, sensitivity corresponding to the target training statement; and determine the noise power for the target training statement based on a preset single-sentence privacy budget and the sensitivity.

In another embodiment, the noise power determining module 541 is configured to determine target budget information for a current iteration round t based on a preset total privacy budget used for a total quantity T of iteration rounds; and determine the noise power for the target training statement based on the target budget information.

In a specific example of this embodiment, the target training statement is obtained through sequential reading from a sample subset used for the current iteration round t, and the sample subset is obtained through sampling from a total local sample set based on a preset sampling probability p; and in this case, the noise power determining module 541 is specifically configured to convert the total privacy budget into a total privacy parameter value in Gaussian differential privacy space; determine a target privacy parameter value for the current iteration round t in the Gaussian differential privacy space based on the total privacy parameter value, the total quantity T of iteration rounds, and the sampling probability p; and determine the noise power based on the target privacy parameter value, the clipping threshold, and a quantity of characters in each training sentence in the sample subset.

Further, the noise power determining module 541 is specifically configured to inversely derive the target privacy parameter value based on a first relational expression for calculating the total privacy parameter value in the Gaussian differential privacy space. The first relational expression shows that the total privacy parameter value is directly proportional to the sampling probability p and a square root of the total quantity T of iteration rounds, and depends on a result of a power operation in which a natural exponent e is used as a base and the target privacy parameter value is used as an exponent.

In different implementations, the encoding network can be implemented by using one of the following neural networks: a long short-term memory network (LSTM), a bidirectional LSTM, and a transformer network.

By using the apparatus, the first party jointly trains the NLP model with the second party when privacy protection is implemented.

According to an embodiment in another aspect, a computer-readable storage medium is further provided. The computer-readable storage medium stores a computer program. When the computer program is executed in a computer, the computer is enabled to perform the method described with reference to FIG. 3.

According to an embodiment in still another aspect, a computing device is further provided, and includes a memory and a processor. The memory stores executable code. When the processor executes the executable code, the method described with reference to FIG. 3 is implemented.

A person skilled in the art should be aware that in the foregoing one or more examples, functions described in this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of this specification are further described in detail in the foregoing specific implementations. It should be understood that the foregoing descriptions are merely specific implementations of this specification, but are not intended to limit the protection scope of this specification. Any modification, equivalent replacement, improvement, and the like made based on the technical solutions of this specification shall fall within the protection scope of this specification.

What is claimed is:

1. A method for jointly training a natural language processing (NLP) model based on privacy protection, wherein the NLP model comprises an encoding network located at a first party and a processing network located at a second party, and the method is performed by the first party and comprises:
obtaining a local target training statement;
inputting the target training statement to the encoding network, and forming a sentence representation vector based on an encoding output of the encoding network; and
adding target noise that conforms to differential privacy to the sentence representation vector, to obtain a target noise addition representation, wherein the target noise addition representation is sent to the second party for training of the processing network.

2. The method according to claim 1, wherein the obtaining a local target training statement comprises:
performing sampling from a total local sample set based on a preset sampling probability p, to obtain a sample subset used for a current iteration round; and
reading the target training statement from the sample subset.

3. The method according to claim 1, wherein the forming a sentence representation vector based on an encoding output of the encoding network comprises:
obtaining a character representation vector obtained after the encoding network encodes each character in the target training statement; and
performing a clipping operation based on a preset clipping threshold on the character representation vector of each character, and forming the sentence representation vector based on a clipped character representation vector.

4. The method according to claim 3, wherein the clipping operation based on a preset clipping threshold comprises:
if a current norm value of the character representation vector exceeds the clipping threshold, determining a ratio of the clipping threshold to the current norm value, and clipping the character representation vector based on the ratio.

5. The method according to claim 3, wherein the forming the sentence representation vector based on a clipped character representation vector comprises:
splicing clipped character representation vectors of all the characters to form the sentence representation vector.

6. The method according to claim 3, before the adding target noise that conforms to differential privacy to the sentence representation vector, further comprising:
determining noise power for the target training statement based on a preset privacy budget; and
obtaining the target noise through sampling from a noise distribution determined based on the noise power.

7. The method according to claim 6, wherein the determining noise power for the target training statement based on a preset privacy budget comprises:
determining, based on the clipping threshold, sensitivity corresponding to the target training statement; and
determining the noise power for the target training statement based on a preset single-sentence privacy budget and the sensitivity.

8. The method according to claim 6, wherein the determining noise power for the target training statement based on a preset privacy budget comprises:
determining target budget information for a current iteration round t based on a preset total privacy budget used for a total quantity T of iteration rounds; and
determining the noise power for the target training statement based on the target budget information.

9. The method according to claim 8, wherein the target training statement is obtained through sequential reading from a sample subset used for the current iteration round t, and the sample subset is obtained through sampling from a total local sample set based on a preset sampling probability p;
the determining target budget information for a current iteration round t comprises:
converting the total privacy budget into a total privacy parameter value in Gaussian differential privacy space; and
determining a target privacy parameter value for the current iteration round t in the Gaussian differential privacy space based on the total privacy parameter value, the total quantity T of iteration rounds, and the sampling probability p; and
the determining the noise power for the target training statement based on the target budget information comprises:
determining the noise power based on the target privacy parameter value, the clipping threshold, and a quantity of characters in each training sentence in the sample subset.

10. The method according to claim 9, wherein the determining a target privacy parameter value for the current iteration round t comprises:
inversely deriving the target privacy parameter value based on a first relational expression for calculating the total privacy parameter value in the Gaussian differential privacy space, wherein the first relational expression shows that the total privacy parameter value is directly proportional to the sampling probability p and a square root of the total quantity T of iteration rounds, and depends on a result of a power operation in which a natural exponent e is used as a base and the target privacy parameter value is used as an exponent.

11. The method according to claim 1, wherein the encoding network is implemented by using one of the following neural networks:
a long short-term memory network (LSTM), a bidirectional LSTM, and a transformer network.

12. An apparatus for jointly training a natural language processing (NLP) model based on privacy protection, wherein the NLP model comprises an encoding network located at a first party and a processing network located at a second party, and the apparatus is deployed at the first party and comprises:
a statement obtaining unit, configured to obtain a local target training statement;
a representation forming unit, configured to input the target training statement to the encoding network, and form a sentence representation vector based on an encoding output of the encoding network; and
a noise addition unit, configured to add target noise that conforms to differential privacy to the sentence representation vector, to obtain a target noise addition representation, wherein the target noise addition representation is sent to the second party for training of the processing network.

13. A computing device, comprising a memory and a processor, wherein the memory stores executable code, and when the processor executes the executable code, the method according to any one of claims 1 to 11 is implemented.
